(19) United States
(12) Patent Application Publication
(10) Pub. No.: US 2024/0310782 A1
(43) Pub. Date: Sep. 19, 2024

(54) METHODS OF HOLOGRAPHIC IMAGE RECONSTRUCTION WITH PHASE RECOVERY AND AUTOFOCUSING USING RECURRENT NEURAL NETWORKS

(71) Applicant: THE REGENTS OF THE UNIVERSITY OF CALIFORNIA, Oakland, CA (US)

(72) Inventors: Aydogan Ozcan, Los Angeles, CA (US); Yair Rivenson, Los Angeles, CA (US); Luzhe Huang, Los Angeles, CA (US); Tairan Liu, Los Angeles, CA (US)

(73) Assignee: THE REGENTS OF THE UNIVERSITY OF CALIFORNIA, Oakland, CA (US)

(21) Appl. No.: 18/546,095

(22) PCT Filed: Feb. 9, 2022
(86) PCT No.: PCT/US2022/015843

§ 371 Date: Aug. 10, 2023

Related U.S. Application Data
(60) Provisional application No. 63/148,545, filed on Feb. 11, 2021.

(51) Int. Cl. G03H 1/08; G03H 1/00; G03H 1/04; G06T 5/50; G06T 5/60

(52) U.S. Cl. CPC G03H 1/0866; G03H 1/0005; G03H 1/0443; G06T 5/50; G06T 5/60; G03H 2001/005; G03H 2001/0458; G03H 2001/0883; G03H 2210/55; G06T 2207/10056; G06T 2207/20084; G06T 2207/30024

(57) ABSTRACT

Digital holography is one of the most widely used label-free microscopy techniques in biomedical imaging. Recovery of the missing phase information of a hologram is an important step in holographic image reconstruction. A convolutional recurrent neural network (RNN)-based phase recovery approach is employed that uses multiple holograms, captured at different sample-to-sensor distances to rapidly reconstruct the phase and amplitude information of a sample, while also performing autofocusing through the same trained neural network. The success of this deep learning-enabled holography method is demonstrated by imaging microscopic features of human tissue samples and Papanicolaou (Pap) smears. These results constitute the first demonstration of the use of recurrent neural networks for holographic imaging and phase recovery, and compared with existing methods, the presented approach improves the reconstructed image quality, while also increasing the depth-of-field and inference speed.

### RELATED APPLICATION

This application claims priority to U.S. Provisional Patent Application No. 63/148,545 filed on Feb. 11, 2021, which is hereby incorporated by reference Priority is claimed pursuant to 35 U.S.C. § 119 and any other applicable statute.

### TECHNICAL FIELD

The technical field generally relates methods and systems used for holographic image reconstruction performed with phase recovery and autofocusing using a trained neural network. While the invention has particular application for phase recovery and image reconstruction for holographic images, the method may also be applied to other intensity-only measurements where phase recovery is needed.

### BACKGROUND

Holography provides a powerful tool to image biological samples, with minimal sample preparation, i.e., without the need for staining, fixation or labeling. The past decades have seen impressive progress in digital holography field, especially in terms of image reconstruction and quantitative phase imaging (QPI) methods, also providing some unique advantages over traditional microscopic imaging modalities by demonstrating field-portable and cost-effective microscopes for high-throughput imaging, biomedical and sensing applications, among others. One core element in all of these holographic imaging systems is the phase recovery step, since an opto-electronic sensor array only records the intensity of the electromagnetic field impinging on the sensor plane. To retrieve the missing phase information of a sample, a wide range of phase retrieval algorithms have been developed; some of these existing algorithms follow a physical model of wave propagation and involve multiple iterations, typically between the hologram and the object planes, in order to recover the missing phase information. Recently, deep learning-based phase retrieval algorithms have also been demonstrated to reconstruct a hologram using a trained neural network. These deep learning-based algorithms outperform conventional iterative phase recovery methods by creating speckle- and twin-image artifact-free object reconstructions in a single-pass forward through a neural network (i.e., without iterations) and provide additional advantages such as improved image reconstruction speed and extended depth-of-field (DOF), also enabling cross-modality image transformations, for example matching the color and spatial contrast of brightfield microscopy in the reconstructed hologram.

### SUMMARY

Here, a new deep learning-based holographic image reconstruction and phase retrieval algorithm is disclosed that is based on a convolutional recurrent neural network (RNN), trained using a generative adversarial network (GAN). This recurrent holographic (RH) imaging framework uses multiple (M) input hologram images that are back-propagated using zero-phase onto a common axial plane to simultaneously perform autofocusing and phase retrieval at its output inference. The efficacy of this method, which is termed RH-M herein, was demonstrated by holographic imaging of human lung tissue sections. Furthermore, by enhancing RH-M with a dilated (D) convolution kernel (FIG. 2B), the same autofocusing and phase retrieval performance is demonstrated without the need for any free-space back-propagation (FSP) step, i.e., the acquired raw holograms of an object are directly used as inputs to a trained RNN for in-focus image reconstruction at its output. This second method, termed RH-MD, is more suitable for relatively sparse samples and its success was demonstrated by holographic imaging of Papanicolaou (Pap) smear samples.

Different from other deep learning-based phase retrieval methods, in order to enhance the image reconstruction quality, this method incorporates multiple holograms, which encode the sample phase in the axial intensity differences. When compared with existing phase retrieval and holographic image reconstruction algorithms, RH-M and RH-MD framework introduces important advantages including superior reconstruction quality and speed, as well as extended DOF through its autofocusing feature. As an example, for imaging lung tissue sections, RH-M achieved ˜40% quality improvement over existing deep learning-based holographic reconstruction methods in terms of the amplitude root mean squared error (RMSE), and was ˜ 15-fold faster in its inference speed compared to iterative phase retrieval algorithms using the same input holograms. The results establish the first demonstration of the use of RNNs in holographic imaging and phase recovery, and the presented framework would be broadly useful for various coherent imaging modalities.

In one embodiment, a method of performing auto-focusing and phase-recovery using a plurality of holographic intensity or amplitude images of a sample (i.e., sample volume) includes obtaining a plurality of holographic intensity or amplitude images of the sample volume at different sample-to-sensor distances using an image sensor and back propagating each one of the holographic intensity or amplitude images to a common axial plane with image processing software to generate a real input image and an imaginary input image of the sample volume calculated from each one of the holographic intensity or amplitude images. A trained convolutional recurrent neural network (RNN) is executed by the image processing software using one or more processors, wherein the trained RNN is trained with holographic images obtained at different sample-to-sensor distances and back-propagated to a common axial plane and their corresponding in-focus phase-recovered ground truth images, wherein the trained RNN is configured to receive a set of real input images and imaginary input images of the sample volume calculated from the plurality of holographic intensity or amplitude images obtained at different sample-to-sensor distances and outputs an in-focus output real image and an in-focus output imaginary image of the sample volume that substantially matches the image quality of the ground truth images.

In another embodiment, a method of performing auto-focusing and phase-recovery using a plurality of holographic intensity or amplitude images of a sample volume includes the operations of obtaining a plurality of holographic intensity or amplitude images of the sample volume at different sample-to-sensor distances using an image sensor. A trained convolutional recurrent neural network (RNN) is executed by the image processing software using one or more processors, wherein the trained RNN is trained with holographic images obtained at different sample-to-sensor distances and their corresponding in-focus phase-recovered ground truth images, wherein the trained RNN is configured to receive a plurality of holographic intensity or amplitude images obtained at different sample-to-sensor distances and outputs an in-focus output real image and an in-focus output imaginary image of the sample volume that substantially matches the image quality of the ground truth images.

### BRIEF DESCRIPTION OF THE DRAWINGS

FIG. 1 schematically illustrates a system according to one embodiment that is used to output or generate autofocused, phase reconstructed images. The system uses as inputs, multiple hologram images obtained at different sample-to-sensor distances and generates in-focused output real image and an output imaginary image of the sample.

FIGS. 2A-2C: Recurrent holographic imaging framework (RH-M and RH-MD). FIG. 2A illustrates a microscope device that obtains raw holograms Iᵢ, i=1, 2, . . . , M, of a sample volume captured at unknown axial positions z_{2,i} located around an arbitrary axial position z̅₂̅. U_{GT} denotes the ground truth (GT) complex field at the sample plane obtained by iterative multi-height phase retrieval (MH-PR) that used eight (8) holograms acquired at different sample-to-sensor distances. Û denotes the retrieved complex field by recurrent holographic imaging networks, and Uᵢ stands for the complex field resulting from the propagation of L by an axial distance of z̅₂̅ using zero phase (i.e., without any phase recovery step) FIG. 2B illustrates the generator (G) network structure of RH-M and RH-MD, and examples of the dilated/non-dilated convolutional kernels and the corresponding receptive fields are shown. The input and output images in RH-M/RH-MD have two channels corresponding to the real and imaginary parts of the optical fields, respectively. FIG. 2C illustrates the discriminator (D) network structure used for training of RH-M and RH-MD using a GAN framework.

FIGS. 3A-3B: Holographic imaging of lung tissue sections. FIG. 3A shows RH-M inference results using M=2 input holograms. FIG. 3B shows holographic imaging with eight (8) holograms (I₁ . . . Iₐ) using the iterative MH-PR algorithm, which constitutes the ground truth.

FIGS. 4A-4B: Holographic imaging of lung tissue sections using RH-M (M=2) and results thereof. FIG. 4A illustrates the retrieved complex field (RH-M output) using M=2 input holograms at various combinations of sample-to-sensor distances. The optimal holographic input combination is highlighted by the solid line border in FIG. 4A, corresponding to the RH-M output with the highest amplitude SSIM. The ground truth field obtained by the iterative MH-PR algorithm using eight (8) holograms/heights is highlighted by the dash-line border. FIG. 4B shows a table of amplitude and phase SSIM values of RH-M output images with M=2 input holograms acquired at various heights (sample-to-sensor distances) around z̅₂̅=450 μm.

FIGS. 5A-SC: Holographic imaging of a Pap smear using RH-M and RH-MD (M=2) and results thereof. FIG. 5A illustrates the RH-MD network directly taking in the raw holograms as its input, while RH-M first back-propagates the input holograms using zero phase to z̅₂̅ and then takes in these back-propagated complex fields as its input. The outputs from RH-M and RH-MD both match the ground truth field very well. FIG. 5B shows the expanded regions of interest (ROI) highlighted by solid boxes in FIG. 5A. The arrows point out some concentric ring artifacts in the ground truth image (created by an out-of-plane particle), which are suppressed by both RH-M and RH-MD. Such out-of-focus particles appear in MH-PR image reconstruction results as they are physically expected, whereas they are suppressed in the RNN output images because both RH-M and RH-MD are trained using 2D samples. Scale bar: 10 μm. FIG. 5C illustrates amplitude and phase SSIM values of the retrieved field from M=2 input holograms at different axial positions around z̅₂̅=500 μm. The SSIM values are calculated within the ROI marked by the dashed line box in FIG. 5A.

FIGS. 6A-6E: RH-M performance comparison against HIDEF using lung tissue sections. FIG. 6A illustrates how the retrieved field by RH-M with M=2 input holograms matches the ground truth very well. FIG. 6B shows the retrieved field by RH-M with M=3 input holograms provides an improved match against the ground truth. FIG. 6C shows the retrieved field by HIDEF using a single input hologram (I₁, I₂ or I₃). The average field that is reported here is calculated by averaging HIDEF(I₁), HIDEF(I₂) and HIDEF(I₃). FIG. 6D illustrates the ground truth field obtained by iterative MH-PR that used eight (8) holograms acquired at different sample-to-sensor distances. FIG. 6E shows the bar plot of the RMSE values of the retrieved field from HIDEF, RH-M with M=2 input holograms (6 selections), RH-M with M=3 input holograms (6 permutations), with respect to the ground truth field shown in FIG. 6D. Scale bar:50 μm.

FIGS. 7A-7C: Extended DOF of RH-M. FIG. 7A shows the amplitude RMSE plot of the output complex fields generated by RH-M (M=2), HIDEF and MH-PR (M=2) as a function of the axial defocus distance; the ground truth field highlighted by the solid rectangle in FIG. 7C is acquired using MH-PR with M=8 holograms. For RH-M (M=2) and MH-PR (M=2), mean and optimal RMSE values over different Δz_{2,1}, Δz_{2,2} defocus combinations are shown. The dashed vertical lines show the axial training range for both HIDEF and RH-M. FIG. 7B illustrates magnified ROIs of HIDEF outputs (middle) and optimal outputs of RH-M (top), and MH-PR (bottom) at each defocus distance are shown below the plot. Outputs of MH-PR (M=2) with extremely low fidelity are omitted. FIG. 7C shows ground truth complex field that is acquired using MH-PR with M=8 holograms. The ROI highlighted by the solid rectangle is magnified. Scale bar: 10 μm.

FIGS. 8A-8B: GAN framework used for training of RH-M and RH-MD. FIG. 8A illustrates the GAN framework for training RH-M, which serves as the generator. D is the discriminator. FIG. 8B illustrates the GAN framework for RH-MD. Generator (G) and discriminator (D) structures are depicted in FIGS. 2B and 2C.

FIG. 9 illustrates a comparison of the reconstruction results achieved by RH-M and RH-MD on back-propagated holograms.

### DETAILED DESCRIPTION OF ILLUSTRATED EMBODIMENTS

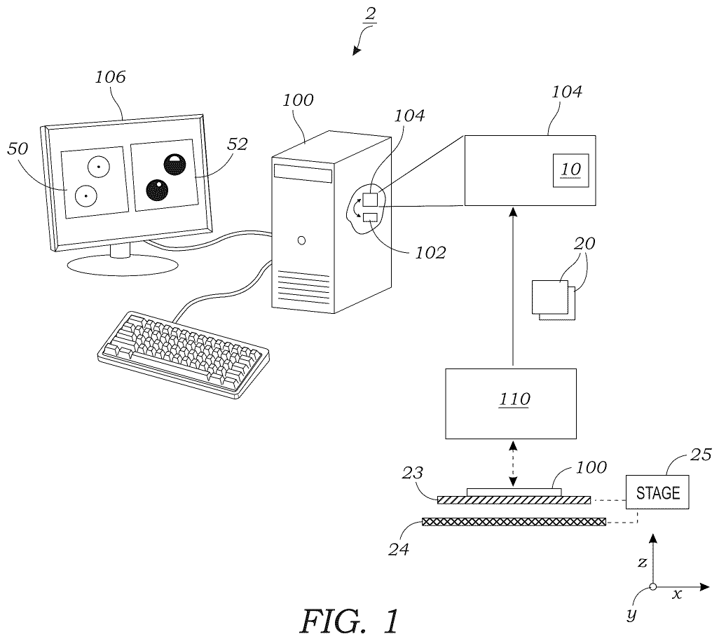

FIG. 1 schematically illustrates one embodiment of a system 2 for outputting one or more autofocused amplitude image(s) 50 and autofocused phase images 52 of a sample volume 22 from a plurality of hologram images 20 captured at different sample-to-sensor distances (in the z direction of FIG. 1). The sample-to-sensor distance is the distance between the sample volume 22 and the image sensor 24. The number of hologram images 20 captured at different sample-to-sensor distances is at least two. The system 2 includes a computing device 100 that contains one or more processors 102 therein and image processing software 104 that is executed by the one or more processors 102 that incorporates a trained convolutional recurrent neural network (RNN) 10. The computing device 100 may include, as explained herein, a personal computer, laptop, tablet, remote server, or the like, although other computing devices may be used (e.g., devices that incorporate one or more graphic processing units (GPUs)). As explained herein, the image processing software 104 can be implemented using, for example, Python and TensorFlow although other software packages and platforms may be used. The trained convolutional RNN 10 is not limited to a particular software platform or programming language and the trained deep neural network 10 may be executed using any number of commercially available software languages or platforms. The image processing software 104 that incorporates or runs in coordination with the trained convolutional RNN 10 may be run in a local environment or a remote cloud-type environment. In some embodiments, some functionality of the image processing software 104 may run in one particular language or platform (e.g., performs free space back-propagation with zero phase) while the trained convolutional RNN 10 may run in another particular language or platform. In other embodiments, all of the image processing functionality including the operations of the trained convolutional RNN 10 may be carried out in a single software application or platform. Regardless, both operations are carried out by image processing software 104.

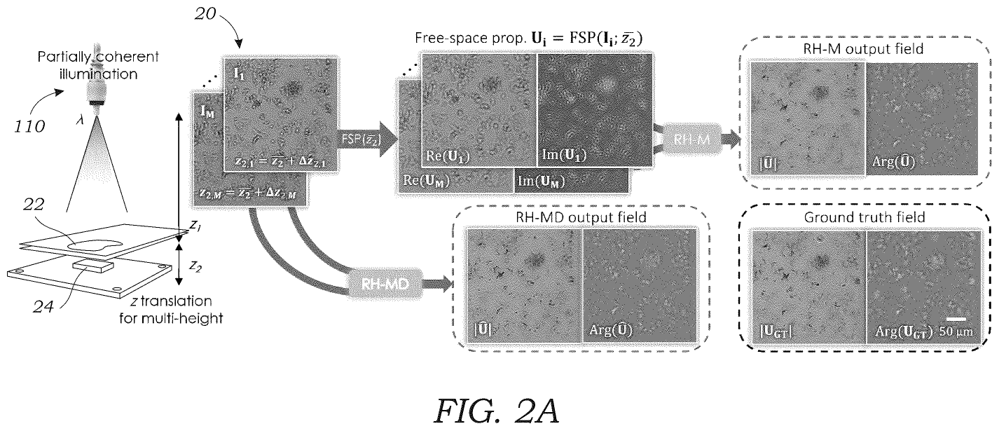

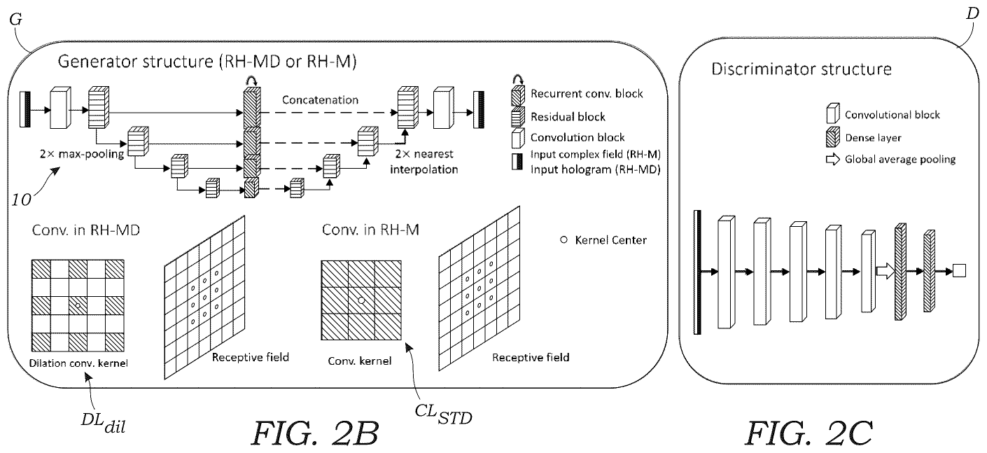

As seen in FIG. 1, in one embodiment, multiple holographic intensity or amplitude images 20 of a sample volume 22 (i.e., sample volume) obtained with an image sensor 24 at different sample-to-sensor distances are subject to a free-space propagation (FSP) operation to back-propagate these hologram images 20 to a common axial plane and result in real and imaginary parts of the complex fields (FIG. 2A). This embodiment includes, for example, the RH-M embodiment described in more detail herein. In other embodiments, the multiple holographic intensity or amplitude images 20 of the sample obtained with the image sensor 24 at different sample-to-sensor distances are not subject to a FSP operation. Here, the trained convolutional recurrent neural network (RNN) 10 performs phase recovery and autofocusing directly from the input holograms without the need for free-space backpropagation using zero-phase and a rough estimate of the sample-to-sensor distance. This method replaces the standard convolutional layers in the trained deep neural network 10 with dilated convolutional layers. An example of this embodiment is referred to as RH-MD as discussed herein (FIG. 2A).

The image sensor 24 may include a CMOS type image sensor that is well known and commercially available. The hologram images 20 are obtained using an imaging device 110, for example, a holographic microscope, a lens-free microscope device, a device that creates or generates an electron hologram image, a device that creates or generates an x-ray hologram image, or other diffraction-based imaging device. The sample volume 22 may include tissue that is disposed on or in an optically transparent substrate 23 (e.g., a glass or plastic slide or the like) such as that illustrated in FIG. 1. In this regard, the sample volume 22 is three dimensional. The sample volume 22 may also include particles, cells, bacteria, viruses, mold, algae, particulate matter, dust or other micro-scale objects (those with micrometer-sized dimensions or smaller) located at various depths within a carrier medium or matrix. The trained convolutional RNN 10 outputs an autofocused output real image 50 (e.g., intensity) and an output imaginary image 52 (e.g., phase image) that substantially matches the image quality of the ground truth images (e.g., those images obtained without the use of a trained neural network using, for example, the multi-height phase retrieval (MH-PR) method described, for example, in Greenbaum, A.; Ozcan, A. Maskless Imaging of Dense Samples Using Pixel Super-Resolution Based Multi-Height Lensfree on-Chip Microscopy. Opt. Express 2012, 20 (3), 3129-3143, which is incorporated by reference herein.

The systems 2 and methods described herein rapidly outputs autofocused output images 50, 52 as explained herein. The images 50, 52 substantially match the corresponding ground truth images obtained using the more complicated multi-height phase recovery (e.g., MH-PR). The output images 50, 52 illustrated in FIG. 1 are shown displayed on a computer monitor 106 but it should be appreciated the output images 50, 52 may be displayed on any suitable display (e.g., computer monitor, tablet computer, mobile computing device, mobile phone, etc.). In some embodiments, only the real (amplitude) image 50 may be displayed or outputted while in other embodiments only the imaginary (phase) image 52 is displayed or outputted. Of course, both the real and imaginary output images 50, 52 by be displayed.

In some embodiments, the input hologram images 20 may include raw hologram images without any further processing. In still other embodiments, the input hologram images 20 may include pixel super-resolution (PSR) images. These PSR images 20 may be obtained by performing lateral scanning of the sample volume 22 and/or image sensor 24 using a moveable stage 25 (FIG. 1) or the like. Sub-pixel shifts are used to generate the high-resolution holograms using, for example, a shift-and-add algorithm. An example of method of obtaining PSR images may be found in Bishara et al., Lensfree on-chip microscopy over a wide field-of-view using pixel super-resolution, Optics Express, 18(11), 11181-11191 (2010), which is incorporated herein by reference.

### Experimental

### Results and Discussion

### Holographic Imaging Using RH-M

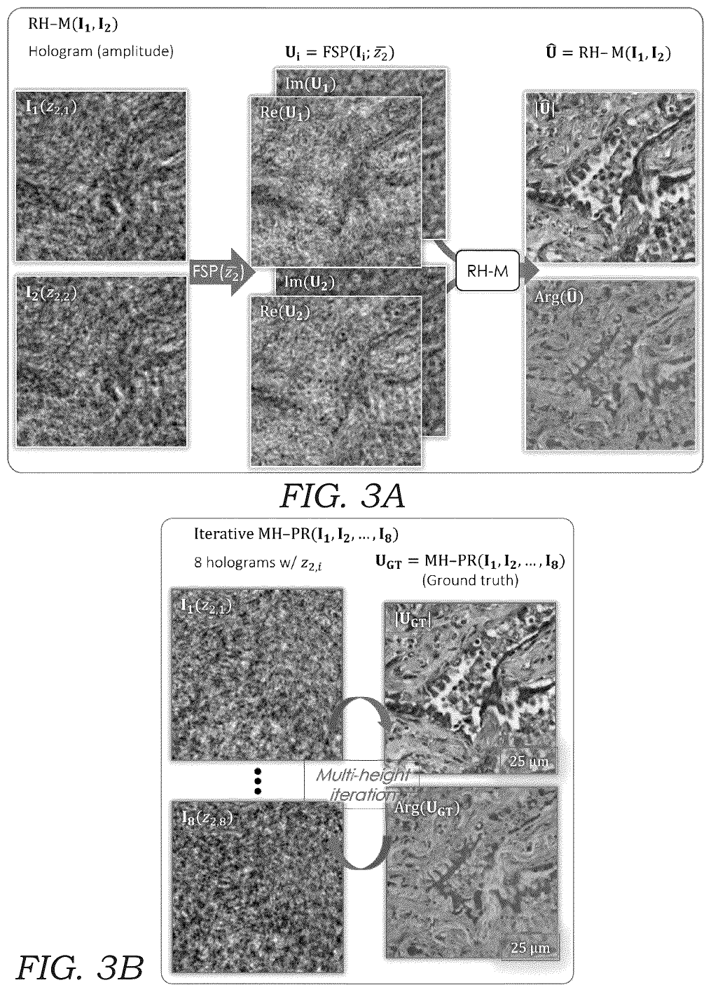

To demonstrate the efficacy of the RH-M imaging method for phase recovery and autofocusing, the RNN 10 was trained and tested (FIG. 2B) using human lung tissue sections, imaged with a lensfree in-line holographic microscope (see Materials and Methods). Three training slides were used, covering ˜60 mm² unique tissue sample field-of-view and one testing slide, covering ˜20 mm² tissue field-of-view; all of these tissue samples were taken from different patients. In the training phase, RH-M randomly took M=2 input holograms with random sample-to-sensor distances ranging from 350 μm to 550 μm, i.e., constituting an axial training range of 450±100 μm; each one of these randomly selected holograms was then propagated to z̅₂=450 μm, without any phase recovery step, i.e., using zero phase. The real and imaginary parts of the resulting complex fields were used as training inputs to RH-M model, where the corresponding ground truth complex images of the same samples were obtained using an iterative multi-height phase retrieval (MH-PR) algorithm described herein that processed eight (8) holograms acquired at different sample-to-sensor distances (see Materials and Methods for further details). In the blind testing phase, to demonstrate the success of the trained RNN model, M=2 holograms of the testing slide (from a different patient, not used during the training) were captured at sample-to-sensor distances of 423.7 μm and 469.7 μm. Both of these test holograms were also back-propagated (using zero phase) to z̅₂=450 μm, which formed the complex fields Uᵢ; the real and imaginary parts of Uᵢ were used as inputs to the trained convolutional RNN 10 to test its inference. The results of the RH-M blind inference with these inputs are summarized in FIGS. 3A-3B, which reveals that the output of the trained convolutional RNN 10, i.e., Û, very well matches the ground truth U_{GT} obtained through the iterative MH-PR algorithm that used eight (8) in-line holograms with accurate knowledge of the sample-to-sensor distances of each hologram plane.

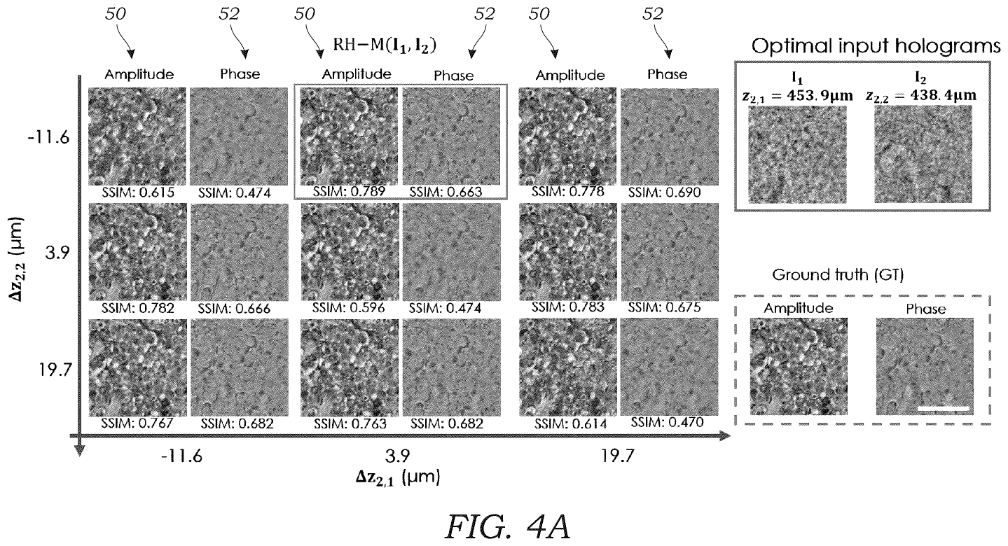

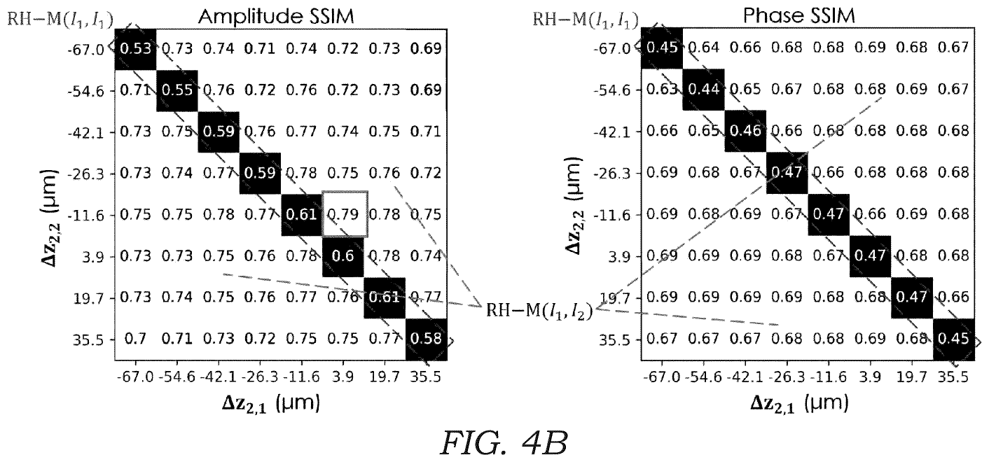

To further analyze RH-M inference performance, a study was performed by feeding the trained RNN 10 with M=2 input holograms, captured at various different combinations of defocusing distances, i.e., Δz_{2,1}, and Δz_{2,2}; the results of this analysis are summarized in FIGS. 4A-4C. First, these results reveal that the presented system 2 and method is successful even when Δz_{2,1}=Δz_{2,2}, which corresponds to the case where the two input holograms are identical. Second, the best image reconstruction performance, in terms of the amplitude channel structural similarity Index (SSIM) is achieved with a defocus combination of Δz_{2·1}=3.9 μm, and Δz_{2,2}=−11.6 μm (see the highlighted rectangle in FIG. 4A), indicating that an axial distance between the two input holograms is preferred to yield better inference for RH-M. The SSIM results reported in FIG. 4B further illustrate that RH-M method can consistently recover the complex object information with various different Δz_{2,1} and Δz_{2,2} combinations, ranging from −67.0 μm to 35.5 μm, i.e., spanning an axial defocus distance of >100 μm. Furthermore, consistent with the visual reconstruction results reported in FIG. 4A, for the case of Δz_{2,1}=Δz_{2,2}, RH-M can successfully recover the object fields, but with relatively degraded SSIM values, as indicated by the diagonal entries in FIG. 4B.

The hyperparameter M is one of the key factors affecting RH-M's performance. Generally, networks with larger M learn higher-order correlations of the input hologram images 20 to better reconstruct a sample's complex field, but can also be vulnerable to overfitting on small training datasets and converging to local minima. Table 1 below summarizes the performance of RH-M trained with different input hologram numbers, M and different training set sizes. All in all, RH-M benefits from training sets with higher diversity and larger M. A general discussion on the selection of M in practical applications is also provided in the Discussion section.

TABLE 1

| Training set size (FOV | | | | | | |
|---|---|---|---|---|---|---|
| per image: 0.2 × 0.2 | | | | | | |
| mm² | | | | | | |
| | # of | | | | | |
| # of input | ground | | | | | |
| hologram | truth | | | | | |
| combinations | images | M = 1 | M = 2 | M = 3 | M = 4 | M = 5 |
| $245 \cdot ( \begin{matrix}8 \\ M\end{matrix} )$ | 245 | 0.201/0.251/0.955 | 0.192/0.255/0.955 | 0.210/0.263/0.950 | 0.178/0.222/0.965 | 0.178/0.217/0.966 |
| $490 \cdot ( \begin{matrix}8 \\ M\end{matrix} )$ | 490 | 0.199/0.246/0.956 | 0.159/0.207/0.971 | 0.161/0.212/0.970 | 0.153/0.203/0.972 | 0.158/0.213/0.969 |
| $979 \cdot ( \begin{matrix}8 \\ M\end{matrix} )$ | 979 | 0.190/0.238/0.950 | 0.167/0.223/0.967 | 0.163/0.214/0.968 | 0.152/0.207/0.972 | 0.152/0.207/0.972 |

| | | | | | |
|---|---|---|---|---|---|
| Inference time | 3.04 | 3.73 | 4.33 | 5.18 | 5.70 |
| (s/mm²) | | | | | |

Table 1: RH-M network reconstruction quality (amplitude RMSE/phase RMSE/ECC) with respect to M and training dataset size.

### Holographic Imaging Using RH-MD

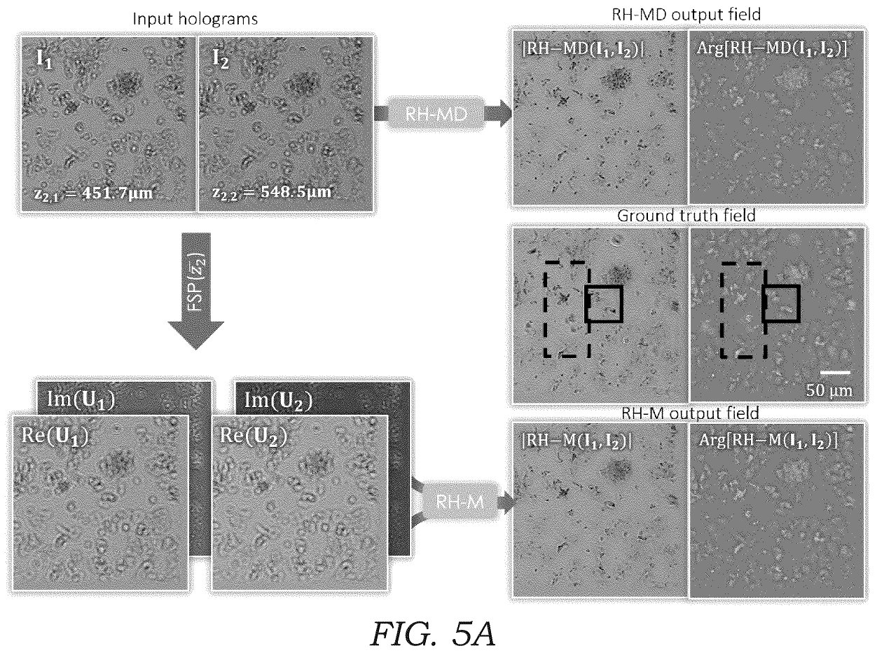

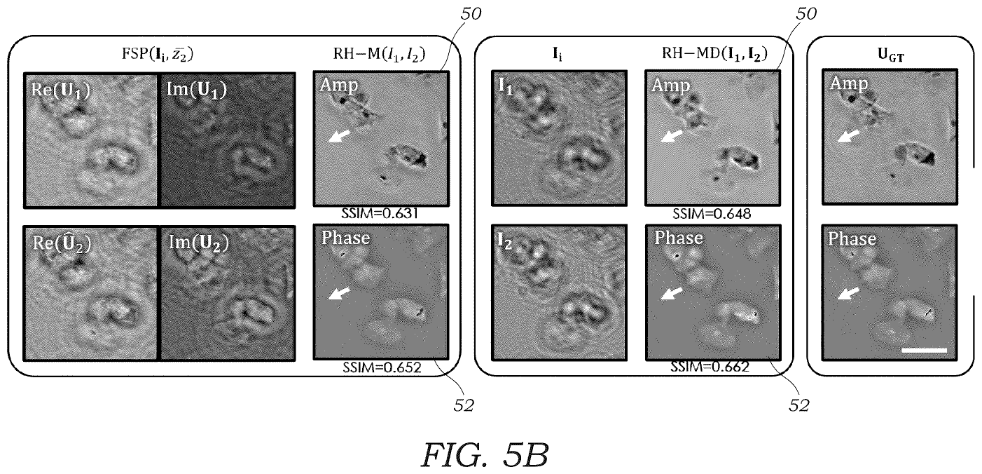

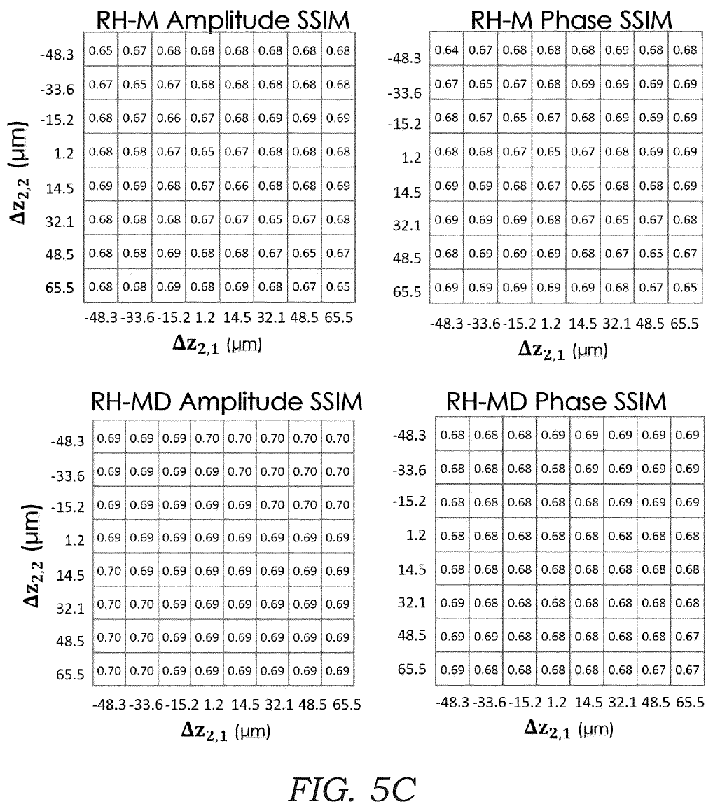

The RH-M framework can also be extended to perform phase recovery and autofocusing directly from input hologram images 20, without the need for free-space backpropagation using zero-phase and a rough estimate of the sample-to-sensor distance, =2 (see FIG. 2A). For this goal, the RH-M framework was enhanced by replacing the standard convolutional layers (CL_{std}) with dilated convolutional layers (DL_{dil}) as shown in FIG. 2B; this special case is referred to as RH-MD. This change enlarged the receptive field of the network, which provides RH-MD the capability to process diffraction patterns over a relatively larger area without increasing the number of trainable parameters, while also allowing one to directly perform phase recovery and autofocusing from raw input hologram images 20. To demonstrate this capability, the RH-MD-based system 2 was trained and tested on Pap smear samples imaged by the same lensfree holographic microscopy platform. Here, the training dataset contains raw in-line holograms with random sample-to-sensor distances ranging from 400 μm to 600 μm, i.e., constituting the training range of 500±100 μm; testing image dataset contains raw holograms of sample fields-of-view that were never seen by the RNN 10 before. FIGS. 5A-5C summarizes the blind inference results of RH-MD and its performance comparison against the results of RH-M for the same test regions of interest. In FIG. 5A, the output images 50, 52 of both RH-M and RH-MD very well match the ground truth complex fields-however, different from RH-M, RH-MD used the raw input hologram images 20 without the need for any free-space backpropagation over z̅₂. As shown in the region-of-interest (ROI) labeled by solid region in FIGS. 5A-5B, both RH-M and RH-MD are able to suppress the concentric ring artifacts induced by some out-of-focus particles (pointed by the arrows); such particles lie outside of the sample plane and therefore, are treated as interference artifacts, and removed by both RH-M and RH-MD since they were trained using two dimensional (2D) samples.

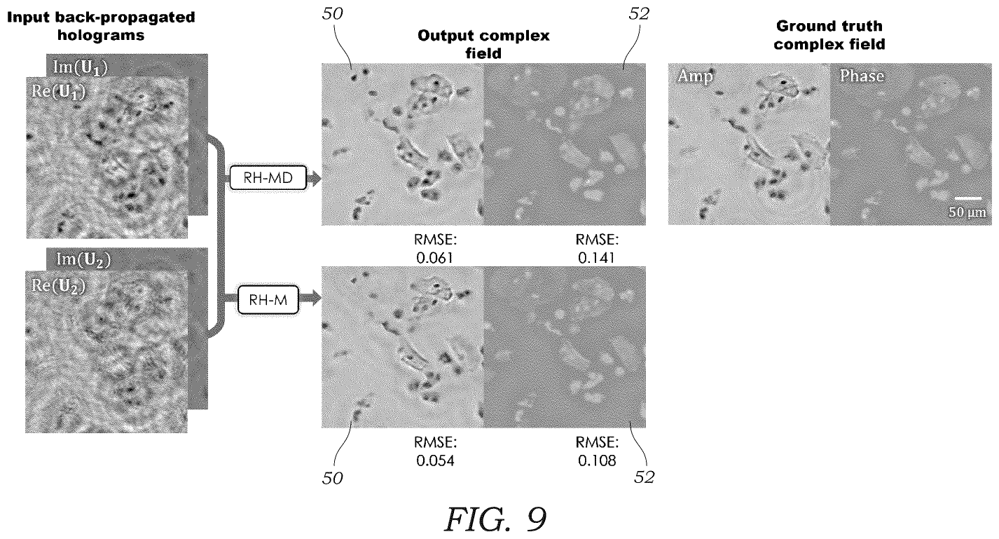

FIG. 5C further illustrates a comparison of the amplitude and phase SSIM values of the output images 50, 52 of RH-M and RH-MD trained convolutional RNNs 10, with respect to the ground truth field. Without the need for back-propagation of input hologram images 20, RH-MD appears to be more robust compared to RH-M when the input hologram images 20 are obtained at the same height (Δz_{2,1}=Δz_{2,2}), as indicated by the diagonal entries in FIG. 5C. These advantages of RH-MD are observed for microscopic imaging of relatively sparse sample volumes 22 such as Pap smear slides reported here; however, for connected tissue sections such as histopathology sample volumes 22 shown in FIGS. 3A, 3B-4A, 4B, 4C, it was observed that the RH-MD inference performance significantly degraded compared to RH-M since for such connected and spatially-dense samples, the differential advantage brought by dilated convolutional layers DL_{dil} disappears due to cross-talk from other features/samples within the field-of-view. Therefore, unlike RH-M, sample sparsity is found to be a requirement for blind phase retrieval, holographic image reconstruction and autofocusing using RH-MD. In addition, the dilated convolution kernel intrinsically filters out some of the high frequency components in the input hologram images 20 and therefore partially impairs the reconstruction quality. FIG. 9 further illustrates the phase retrieval and image reconstruction results achieved by RH-M and RH-MD networks 10 on back-propagated holograms, where RH-MD clearly underperforms when compared with RH-M, as also quantified in Table 2.

TABLE 2

| | Amp. RMSE | Phase RMSE | ECC |
|---|---|---|---|
| RH-M | 0.056 ± 0.002 | 0.111 ± 0.007 | 0.994 ± 0.001 |
| RH-MD + FSP | 0.060 ± 0.002 | 0.138 ± 0.006 | 0.992 ± 0.001 |
| p-value | 6.54e−21 (*) | 3.36e−47 (*) | 6.54e−21 (*) |

Table 2: Quantitative comparison of RH-M and RH-MD image reconstruction results on back-propagated holograms. Metrics were calculated based on 64 different input hologram combinations.

### Performance Comparisons

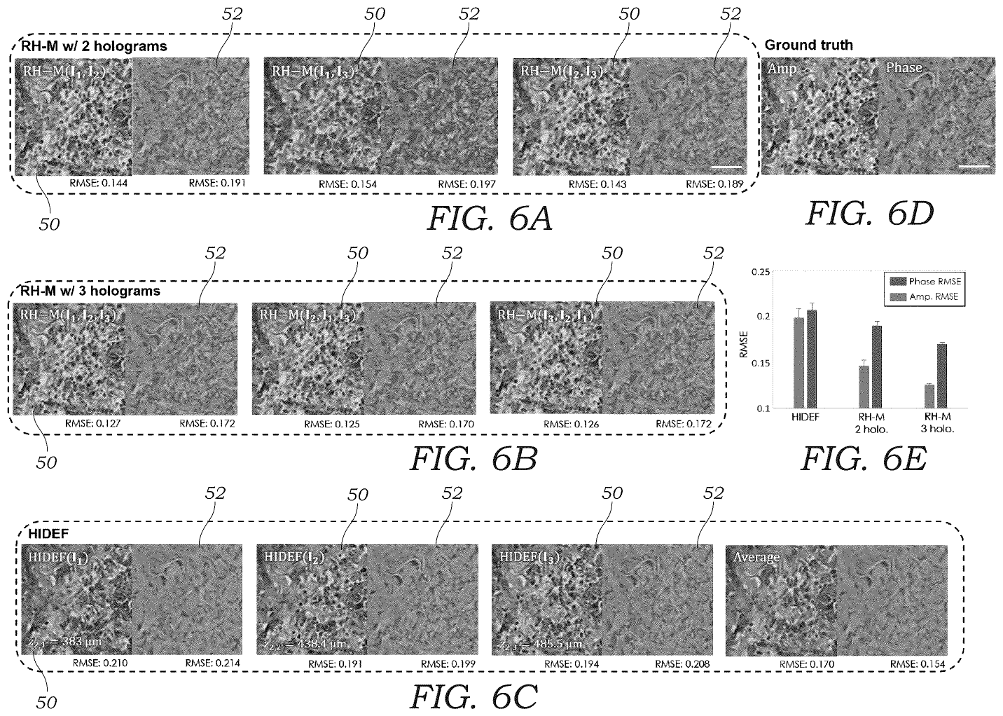

To further demonstrate the advantages of the presented RNN-based system 2 and method over existing neural network-based phase recovery and holographic image reconstruction methods, the performance of RH-M was compared to an earlier method, termed Holographic Imaging using Deep Learning for Extended Focus (HIDEF), described in Wu et al., Extended depth-of-field in holographic imaging using deep-learning-based autofocusing and phase recovery, Optica, 5: 704 (2018), which is incorporated herein by reference. This previous framework, HIDEF, used a trained convolutional neural network (CNN) to perform both autofocusing and phase retrieval with a single hologram that is back-propagated using zero-phase. For providing a quantitative comparison of RH-M and HIDEF, both algorithms were tested using three (3) holograms of lung tissue sections that were acquired at different sample-to-sensor distances of 383, 438.4 and 485.5 μm (see FIGS. 6A-6D). Both HIDEF and RH-M used the same 22=450 μm in the initial back-propagation step (using zero-phase), and by design HIDEF takes in one hologram each time. As shown in FIGS. 6A-6C, RH-M achieved a superior image reconstruction quality compared to HIDEF through the utilization of multiple hologram images 20, providing ˜40% improvement in terms of the amplitude RMSE (ground truth images are seen in FIG. 6D). FIG. 6E further summarizes the mean and the standard deviation of RMSE values for RH-M output images 50, 52 and HIDEF output images, showing the statistical significance of this improvement. Benefitting from its recurrent scheme, the RH-M-based convolutional RNN 10 can easily adapt to a variable number of input hologram images 20, e.g., M=2 or M=3, although the RNN was trained with fixed number of input hologram images 20. By adding one more input hologram image 20, the RH-M output is further improved as illustrated in FIG. 6E; see the results for M=2 vs. M=3. Furthermore, it is important to note that RH-M has a very good inference stability with respect to the order of the input hologram images 20. FIGS. 6A and 6B illustrate the consistency of the retrieved field by RH-M over different selections and/or permutations of the input holograms. This feature of RH-M provides great flexibility and advantage in the acquisition of raw hologram images 20 without the need for accurate axial sampling or a fixed scanning direction/grid.

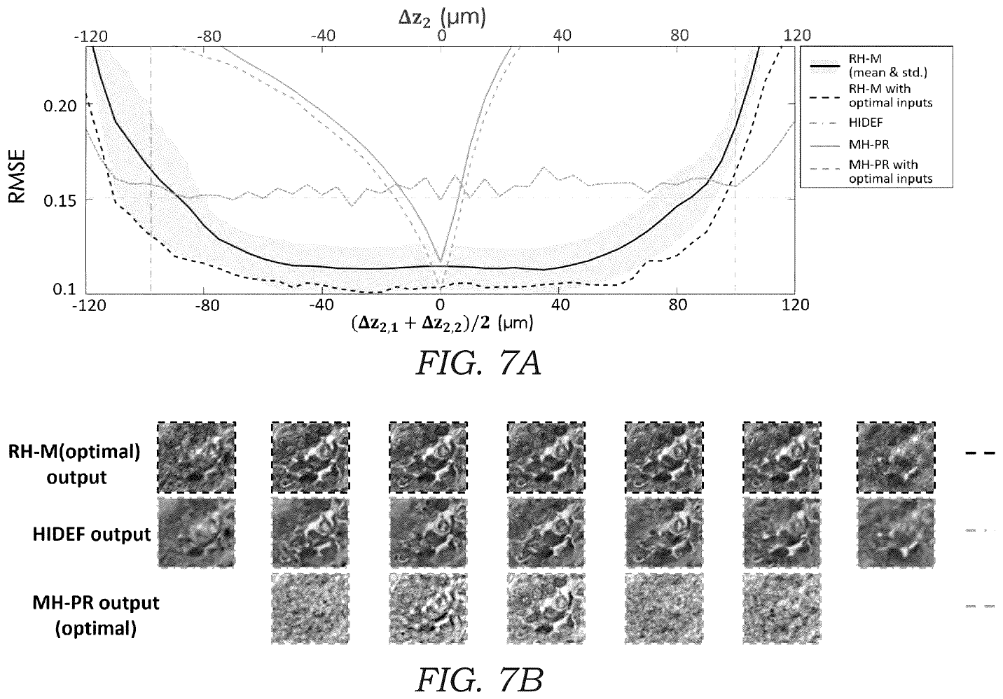

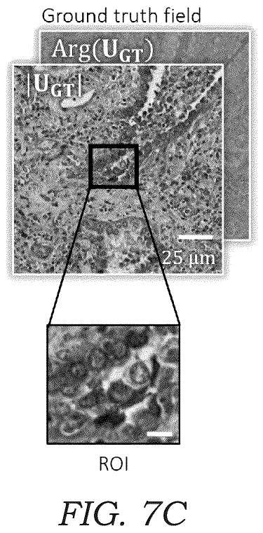

Another important advantage of RH-M is the extended DOF that it offers, over both HIDEF and MH-PR results. In FIGS. 7A-7C, simulated input hologram images 20 were generated with sample-to-sensor distances ranging from 300 μm to 600 μm, and then back-propagated using zero-phase onto the same axial plane, z̅₂̅=450 μm. FIG. 7A illustrates the RMSE values of the amplitude channel of each output field as a function of the defocus distance Δz₂ generated by RH-M (solid line and shadow), MH-PR and HIDEF, where RH-M (M=2) and MH-PR (M=2) used the average defocus distance of the two input hologram images 20. For RH-M and MH-PR, where two input hologram images 20 are present, the mean and optimal RMSE values over all Δz_{2,1}, Δz_{2,2} defocus combinations are shown by the solid and dashed lines, respectively, and the indicate the standard deviations of the RMSE values for each case. The quantitative comparisons presented in FIG. 7A clearly reveal the DOF advantage of RH-M output images, also demonstrating better image quality as evidenced by the lower RMSE values, which is also supported by the visual comparisons provided in FIG. 7B. The ground truth complex field is illustrated in FIG. 7C.

Finally, in Table 3, the output inference (or image reconstruction) speed of RH-M, RH-MD, HIDEF and MH-PR algorithms using Pap smear and lung tissue samples were compared. As shown in Table 3, among these phase retrieval and holographic image reconstruction algorithms, RH-M and RH-MD are the fastest, achieving ˜50-fold and ˜15-fold reconstruction speed improvement compared with MH-PR (M=8 and M=2, respectively); unlike RH-M or RH-MD, the performance of MH-PR is also dependent on the accuracy of the knowledge/measurement of the sample-to-sensor distance for each raw hologram, which is not the case for the RNN-based hologram reconstruction methods reported here.

TABLE 3

| | | | Training dataset size (FOV | |
|---|---|---|---|---|
| | | | per image: 0.2 × 0.2 mm²) | |
| | | Inference | # of input | |
| | # trainable | time | hologram | # of ground |
| Algorithm | parameters | (s/mm²) | combinations | truth images |
| RH-M (M = 2) | 14.1M | 0.162 | 5.8K | 208 |
| RH-M (M = 3) | 14.1M | 0.200 | 11.6K | 208 |
| RH-MD (M = 2) | 14.1M | 0.154 | 5.8K | 208 |
| MH-PR (M = 2) | NA | 2.467 | NA | |
| MH-PR (M = 3) | NA | 3.280 | NA | |
| MH-PR (M = 8) | NA | 7.944 | NA | |
| HIDEF | 3.9M | 0.352 | 1.7K | 208 |

The system 2 uses an RNN-based phase retrieval method that incorporates sequential input hologram images 20 to perform holographic image reconstruction with autofocusing. The trained RNN network 10 is applicable to a wide spectrum of imaging modalities and applications, including e.g., volumetric fluorescence imaging. Recurrent blocks learn to integrate information from a sequence of 2D microscopic scans that can be acquired rapidly to reconstruct the 3D sample information with high fidelity and achieve unique advantages such as an extended imaging DOF. In practice, when applying the presented RNN framework to different microscopy modalities and specific imaging tasks, two important factors should be taken into consideration: (1) the image sequence length M, and (2) physics-informed data preprocessing. As Table 1 suggests, increasing the input sequence length generally improves the reconstruction quality, whereas the training process with a larger M requires a more diverse dataset and costs more time in general. Besides, in view of the linearly increasing inference time with respect to the input sequence length, users should accordingly select a proper M to balance the tradeoff between the imaging system throughput and the improvement gained by multiple inputs, M. During the blind testing phase, a RNN network 10 trained with a larger M is in general more flexible to take in shorter sequences, but adequate padding needs to be applied to match the sequence length. Furthermore, physics-informed preprocessing could transform the raw microscopic images into a domain that has an easier and physically meaningful mapping to the target domain. Here, for example, the free space propagation was applied before RH-M to reduce the diffraction pattern size of the object field (despite the missing phase information and the twin-image artifacts that are present). Overall, the design of this preprocessing part should be based on the underlying physical imaging model and human knowledge/expertise.

### Materials and Methods

### Holographic Microscopy Hardware and Imaging of Samples

Raw holograms images 20 were collected using a lensfree in-line holographic microscopy setup shown in FIG. 2A. A broadband light source (WhiteLase Micro, NKT Photonics) filtered by an acousto-optic tunable filter (AOTF) was used as the illumination source (530 nm). A complementary metal-oxide semiconductor (CMOS) color image sensor 24 (IMX 081, Sony, pixel size of 1.12 μm) was used to capture the raw hologram images 20. The sample volume 22 was directly placed between the illumination source and the sensor plane with a sample-to-source distance (z₁) of ˜5-10 cm, and a sample-to-sensor distance (z₂) of ˜300-600 μm. The image sensor 24 was attached to a 3D positioning stage (e.g., stage 25 in FIG. 1) (MAX606, Thorlabs, Inc.) to capture holograms at different lateral and axial positions to perform pixel super-resolution and multi-height phase recovery, respectively. All imaging hardware was controlled by a customized LabVIEW program to complete the data acquisition automatically.

All the human samples (of sample volume 22) imaged were obtained after deidentification of the patient information and were prepared from existing specimen; therefore, this did not interfere with standard practices of medical care or sample collection procedures.

### Pixel Super-Resolution

A pixel super-resolution algorithm was implemented to enhance the hologram resolution in the hologram images 20 and bring the effective image pixel size from 2.24 μm down to 0.37 μm. To perform this, in-line holograms at 6-by-6 lateral positions were captured with sub-pixel spacing using a 3D positioning stage (MAX606, Thorlabs, Inc.). The accurate relative displacements/shifts were estimated by an image correlation-based algorithm and the high-resolution hologram was generated using the shift-and-add algorithm. The resulting super-resolved holograms (also referred to as raw hologram images 20) were used for phase retrieval and holographic imaging, as reported in the Results section.

### Angular Spectrum-Based Field Propagation

The angular spectrum-based field propagation was employed for both the holographic autofocusing and the multi-height phase recovery algorithms. This numerical propagation procedure enables one to propagate the initial complex optical field at z=z₀ to obtain the complex optical field at z=z₀+Δz. A 2D Fourier transform is first applied on the initial complex optical field ((x, y; z₀) and the resulting angular spectrum is then multiplied by a spatial frequency-dependent phase factor parametrized by the wavelength, refractive index of the medium, and the propagation distance in free-space (Δz). Finally, to retrieve the complex optical field at z=z₀+Δz, i.e., ((x, y; z₀+Δz), an inverse 2D Fourier transform is applied. It should be appreciated that the plurality of obtained holographic intensity or amplitude images may be back propagated by angular spectrum propagation (ASP) or a transformation that is an approximation to ASP executed by image processing software 104.

### Multi-Height Phase Recovery

In-line holograms at different axial positions, with e.g., ˜15 μm spacing, were captured to perform MH-PR. The relative axial distances between different holograms were estimated using an autofocusing algorithm based on the edge sparsity criterion. The iterative MH-PR algorithm first takes the amplitude of the hologram captured at the first height (i.e., z_{2,1}) and pads an all-zero phase channel to it. It then propagates the resulting field to different hologram heights, where the amplitude channel is updated at each height by averaging the amplitude channel of the propagated field with the measured amplitude of the hologram acquired at that corresponding height. This iterative algorithm converges typically after 10-30 iterations, where one iteration is complete after all the measured holograms have been used as part of the multi-height amplitude updates. Finally, the converged complex field is backpropagated onto the sample plane using the sample-to-sensor distance determined by the autofocusing algorithm. To generate the ground truth images for the network training and testing phases, in-line holograms at eight (8) different heights were used for both the lung and the Pap smear samples reported herein.

### Network Structure

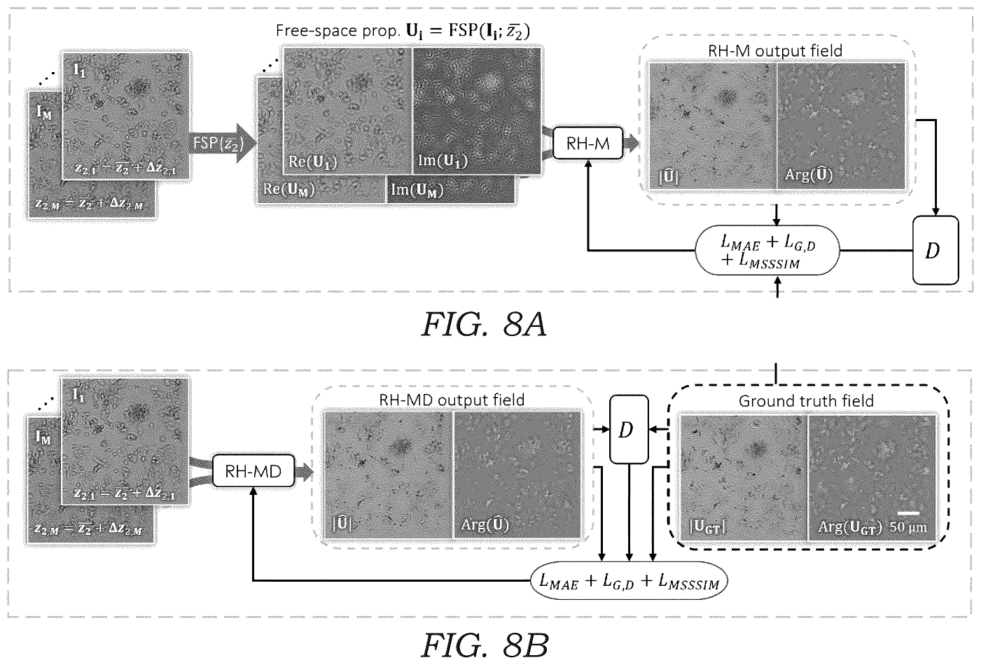

RH-M and RH-MD adapt the GAN framework for their training, which is depicted in FIGS. 8A and 8B. As shown in FIG. 2B, RH-M and RH-MD, i.e., the generators, share the same convolutional RNN structure, which consists of down- and up-sampling paths with consecutive convolutional blocks at four (4) different scales. Between the convolutional blocks at the same scale on the down- and up-sampling paths, a convolutional recurrent block connects them and passes high frequency features. The number of channels of the i-th convolution layer at the k-th convolution block (where k=1, 2, 3, 4, and i=1, 2) of RH-M and RH-MD are 20×2^{k-3+i} and 16×2^{k-3+i} respectively. For RH-MD, the convolution layer in each block applies a dilated kernel with a dilation rate of 2 (FIG. 2B). The convolutional recurrent block follows the structure of one convolutional gated recurrent unit (CGRU) layer and one 1×1 convolution layer. As illustrated in FIG. 2C, a standard CNN with 5 convolutional blocks and 2 dense layers was adapted to serve as the discriminator (D) in the GAN framework. The k-th convolutional block of the discriminator has two convolutional layers with 20×2^{k-1} channels and each layer uses a 3×3 kernel with a stride of 1.

### Network Implementation

After pixel super-resolution and multi-height based phase recovery steps, the resulting hologram images 20 along with the retrieved ground truth images were cropped into non-overlapping patches of 512×512 pixels, each corresponding to ˜0.2×0.2 mm² unique sample field of view. For a given M, a combination of (_{M}^{H}) input holograms can be selected for each ground truth image patch during the training and testing phases, where H stands for the number of heights (H=8 in this work). As an example, Table 3 summarizes the training dataset size for RH-M and RH-MD networks for Pap smear tissue sections. RH-M and RH-MD were implemented using TensorFlow with Python and CUDA environments, and trained on a computer with Intel Xeon W-2195 processor, 256 GB memory and one NVIDIA RTX 2080 Ti graphic processing unit (GPU) In the training phase, for each image patch, Mₜᵣₐₘ holograms were randomly selected from different heights (sample-to-sensor distances) as the network input, and then the corresponding output field of RH-M or RH-MD was sent to the discriminator (D) network.

The generator loss L_{G} is the weighted sum of three different loss terms: (1) pixel-wise mean absolute error (MAE), L_{MAE}, (2) multi-scale structural similarity (MSSSIM) L_{MSSSIM} between the network output ŷ and the ground truth y, and (3) the adversarial loss L_{GD} from the discriminator network. Based on these, the total generator loss can be expressed as:

$${L}_{G} = α {L}_{MAE} + β {L}_{MSSSIM} + γ {L}_{G , D} \qquad ( 1 )$$

where α, β, γ are relative weights, empirically set as 3, 1, 0.5, respectively. The MAE and MSSSIM losses are defined as:

$${L}_{MAE} = \frac{{\sum }_{i = 1}^{n} \vert \hat{y} ( i ) - y ( i ) \vert}{n} \qquad ( 2 )$$

$${L}_{MSSSIM} = \text{} 1 - {[ \frac{2 {μ}_{{\hat{y}}_{m}} {μ}_{{y}_{m}} + {C}_{1}}{{μ}_{{\hat{y}}_{m}}^{2} + {μ}_{{y}_{m}}^{2} + {C}_{1}} ]}^{{α}_{m}} \cdot {{{\prod }_{j = 1}^{m} [ \frac{2 {σ}_{{\hat{y}}_{j}} {σ}_{{y}_{j}} + {C}_{2}}{{σ}_{{\hat{y}}_{j}}^{2} + {σ}_{{y}_{j}}^{2} + {C}_{2}} ]}^{{β}_{j}} [ \frac{{σ}_{{\hat{y}}_{j} {y}_{j}} + {C}_{3}}{{σ}_{{\hat{y}}_{j}} {σ}_{{y}_{j}} + {C}_{3}} ]}^{{γ}_{j}} \qquad ( 3 )$$

where n is the total number of pixels in y, and ŷⱼ, yⱼ are 2^{j-1} downsampled images of ŷ, y, respectively. μ_{y}, σ_{y}² represent the mean and variance of the image y, respectively, while σ_{y}_{ⱼ}_{y}_{ⱼ} is the covariance between ŷⱼ and yⱼ. C₁, C₂, C₃, αₘ, βⱼ, γⱼ, m are pre-defined empirical hyperparameters. The adversarial loss L_{GD} and the total discriminator loss LD are calculated as follows:

$${L}_{G , D} = {[ D ( \hat{y} ) - 1 ]}^{2} \qquad ( 4 )$$

$${L}_{D} = \frac{1}{2} {D ( \hat{y} )}^{2} + {\frac{1}{2} [ D ( y ) - 1 ]}^{2} \qquad ( 5 )$$

Adam optimizers with decaying learning rates, initially set as 5×10⁻⁵ and 1×10⁻⁶, were employed for the optimization of the generator and discriminator networks, respectively. After ˜30 hours of training, corresponding to ˜10 epochs, the training was stopped to avoid possible overfitting.

In the testing phase of RH-M and RH-MD, the convolutional RNN was optimized for mixed precision computation. In general, a trained RNN can be fed with input sequences of variable length. In the experiments, RH-M/RH-MD was trained on datasets with fixed number of inputs (holograms) to save time, i.e., fixed Mₜᵣₐᵢₙ, and later tested on testing data with no more than Mₜᵣₐᵢₙ input holograms (i.e., Mₜₑₛₜ≤ Mₜᵣₐₘ). In consideration of the convergence of recurrent units, shorter testing sequences (where Mₜₑₛₜ<Mₜᵣₐᵢₙ) were replication-padded to match the length of the training sequences Mₜᵣₐᵢₙ. For example, in FIG. 6, the RH-M was trained solely on datasets with 3 input holograms and tested with 2 or 3 input holograms.

HIDEF networks were trained in the same way as detailed in Wu et al., Extended depth-of-field in holographic imaging using deep-learning-based autofocusing and phase recovery, Optica, 5: 704 (2018). Blind testing and comparison of all the algorithms (HIDEF, RH-M, RH-MD and MH-PR) were implemented on a computer with Intel Core i9-9820X processor, 128 GB memory and one NVIDIA TITAN RTX graphic card using GPU acceleration, and the details, including the number of parameters and inference times are summarized in Table 3.

While embodiments of the present invention have been shown and described, various modifications may be made without departing from the scope of the present invention. The invention, therefore, should not be limited, except to the following claims, and their equivalents.

1. A method of performing auto-focusing and phase-recovery using a plurality of holographic intensity or amplitude images of a sample volume comprising:
obtaining a plurality of holographic intensity or amplitude images of the sample volume at different sample-to-sensor distances using an image sensor;
back propagating each one of the holographic intensity or amplitude images to a common axial plane with image processing software to generate a real input image and an imaginary input image of the sample volume calculated from each one of the holographic intensity or amplitude images; and
providing a trained convolutional recurrent neural network (RNN) that is executed by the image processing software using one or more processors, wherein the trained RNN is trained with holographic images obtained at different sample-to-sensor distances and back-propagated to a common axial plane and their corresponding in-focus phase-recovered ground truth images, wherein the trained RNN is configured to receive a set of real input images and imaginary input images of the sample volume, generated from the plurality of holographic intensity or amplitude images obtained at different sample-to-sensor distances and outputs an in-focus output real image and an in-focus output imaginary image of the sample volume, substantially matching the image quality of the ground truth images.

2. The method of claim 1, wherein the plurality of the obtained holographic intensity or amplitude images comprises two or more holographic images.

3. The method of claim 1, wherein the plurality of obtained holographic intensity or amplitude images comprise super-resolved holographic images of the sample volume.

4. The method of claim 1, wherein the plurality of obtained holographic intensity or amplitude images are obtained over an axial defocus range of at least 100 μm.

5. The method of claim 1, wherein the sample volume comprises a tissue block, a tissue section, particles, cells, bacteria, viruses, mold, algae, particulate matter, dust or other micro-scale objects located at various depths within the sample volume.

6. The method of claim 1, wherein twin-image and/or interference-related artifacts are substantially suppressed or eliminated in the output.

7. The method of claim 1, wherein the corresponding in-focus phase-recovered ground truth images are obtained using a phase recovery algorithm.

8. The method of claim 1, wherein the plurality of obtained holographic intensity or amplitude images of the sample volume comprises a stained or unstained tissue sample.

9. The method of claim 1, wherein the plurality of obtained holographic intensity or amplitude images are back propagated by angular spectrum propagation (ASP) or a transformation that is an approximation to ASP executed by image processing software.

10. A method of performing auto-focusing and phase-recovery using a plurality of holographic intensity or amplitude images of a sample volume comprising:
obtaining a plurality of holographic intensity or amplitude images of the sample volume at different sample-to-sensor distances using an image sensor; and
providing a trained convolutional recurrent neural network (RNN) that is executed by the image processing software using one or more processors, wherein the trained RNN is trained with holographic images obtained at different sample-to-sensor distances and their corresponding in-focus phase-recovered ground truth images, wherein the trained RNN is configured to receive a plurality of holographic intensity or amplitude images obtained at different sample-to-sensor distances and outputs an in-focus output real image and an in-focus output imaginary image of the sample volume, substantially matching the image quality of the ground truth images.

11. The method of claim 10, wherein the trained RNN comprises a plurality of dilated convolutional layers.

12. The method of claim 10, wherein the plurality of obtained holographic intensity or amplitude images comprises two or more holographic images.

13. The method of claim 10, wherein the plurality of obtained holographic intensity or amplitude images comprise super-resolved holographic images of the sample volume.

14. The method of claim 10, wherein the plurality of obtained holographic intensity or amplitude images are obtained over an axial defocus range of at least 100 μm.

15. The method of claim 10, wherein the sample volume comprises tissue blocks, tissue sections, particles, cells, bacteria, viruses, mold, algae, particulate matter, dust or other micro-scale objects located at various depths within the sample volume.

16. The method of claim 10, wherein twin-image and/or interference-related artifacts are substantially suppressed or eliminated in the output images of the sample volume.

17. The method of claim 10, wherein the corresponding in-focus phase-recovered ground truth images are obtained using a phase recovery algorithm.

18. The method of claim 10, wherein the plurality of obtained holographic intensity or amplitude images of the sample volume comprises a stained or an unstained tissue sample.
